(19) United States
(12) Patent Application Publication
(10) Pub. No.: US 2005/0144633 A1
(43) Pub. Date: Jun. 30, 2005

(54) World-wide non-time based poll method for determining best image of a child

(76) Inventor: Yuri A. Babayan, Aurora, CO (US)

Correspondence Address: The Law Office of Craig W. Barber, PO Box 16220, Golden, CO, 80402-6004, US

(21) Appl. No.: 10/751,339

(22) Filed: Dec. 31, 2003

(51) Int. Cl. H04N 5/445; G06F 13/00; G06F 3/00; H04N 7/173; H04N 7/16

(52) U.S. Cl. 725/24; 725/23; 725/135; 725/37; 725/13

(57) ABSTRACT

A world-wide and non-time based method of comparing images of children and determining the best child image, in which a child image of any person may be used. Instead of placing a time based restriction on images to be compared, images from any date from the inception of photography until the present may be used. No limitation on present age of the individual pictured, age of the photograph, or the like is used. The method may be embodied as a search, or as a contest or game. It may be embodied as a method of playing a game at home, a method of playing a television game, as an Internet method, as an advertising/business method, and as combinations thereof.

### STATEMENT REGARDING FEDERALLY FUNDED RESEARCH

This invention was not made under contract with an agency of the US Government, nor by any agency of the US Government.

### FIELD OF THE INVENTION

This invention relates generally to methods of comparing child images and specifically to a world-wide and non-time based method for determining the best image of a child.

### CROSS-REFERENCE TO RELATED APPLICATIONS

N/A.

### BACKGROUND OF THE INVENTION

Systematic and scientific determination of favorable images of children is a goal with methods not yet well documented. In general, numerous difficulties relating to temporal, regional and cultural differences, obstacles to long term polling and so on have prevented such attempts. Such a determination, however, can be commercially rewarding, if an acceptable method can be determined.

Prior art methods all suffer from a “time bound” limitation. On a certain date, normally the date of the end of the contest, the contestants must be within a certain age range. One example of this is the traditional beauty pageant, in which all contestants must be in a certain age range, whether the age range is 18-23 years of age or 5-6 years of age or some other age bracket.

There are a number of contest types which all contain this limitation in explicit or implicit form.

The traditional “on stage” or “on television” show normally has such a limitation very clearly spelled out prior to accepting entrants. Prior to the invention of television and other electronic communications, there was no opportunity for contestants to compete before the general public outside the actual physical room in which the contest was held.

Newer Internet and interactive television shows have the same limitation implied, as do contests which allow the use of the use images. For example, contests which feature competitions between images normally impose an age limit as of a certain date, such as “pictures of children aged 7 as of Jan. 1^{st}, 2005”. Another option is to use a jury of extremely critical judges, thus potentially exposing the contestants potential public embarrassment and thereby ensuring that only those with both great beauty and great self confidence compete. In addition, such contests suffer from a great degree of cultural bias: some regions are better equipped with Internet access, or have higher wealth, and thus have higher rates of household Internet penetration. As an example of this difficulty, Internet political and sociological polls are considered virtually worthless in a scientific sense.

Thus none of these prior art approaches serve the non-contest need and goal for a scientific or social study across cultural and racial lines for locating an image representing humanity in general, children in general, or if necessary sub-sets thereof.

It would be advantageous to provide a system by which children of all times and eras, regardless of present day age, could compete against each other with a more scientific goal and method.

It would be more generally advantageous to provide a non-temporal system by which individuals could compete against each other regardless of present day age.

It would further be advantageous to provide methods of commercially utilizing the value of a non-time bound contest of this type.

It would further be advantageous to provide methods of assembling commercially databases of childhood images for later scientific and cultural research purposes.

### SUMMARY OF THE INVENTION

General Summary

A world-wide and non-time based method of comparing images of children and determining the best child image, in which a child image of any person may be used with a more scientific goal and method. Instead of placing a time based restriction on images to be compared, images from any date from the inception of photography until the present may be used. No limitation on present age of the individual pictured, age of the photograph, or the like is used. The method may be embodied as a search, or as a contest or game. It may be embodied as a method of playing a game at home, a method of playing a television game, as an Internet method, as an advertising/business method, and as combinations thereof.

It may be embodied as a sociological search or determination of cultural values of beauty, as a trans-cultural unification symbol, or a scientific inquiry. The method may include variable vote weighting depending upon Internet penetration rates, response rates and other variables and thus provide a weighted voting system.

After the termination of the contest or research, the assembled database of accepted images may be maintained publicly accessible for a long term resource for scientific and cultural research.

Summary in Reference to Claims

It is a first aspect, advantage, objective and embodiment to provide a method of comparing images of children comprising: providing a reception device capable of accepting from contestants images of children from any time since the inception of photography; providing a filtering device capable of filtering out unacceptable photographs, wherein images of children from any time since the inception of photography are acceptable; displaying publicly accepted pictures; providing a voting device capable of accepting and counting votes from viewers; and providing publicly a vote count of the images, whereby images of children from any time since the inception of photography may be compared by means of a poll.

It is another aspect, advantage, objective and embodiment to provide a method wherein: the reception device further comprises an Internet website device having a first module programmed to accept images uploaded by contestants; the step of displaying publicly the accepted pictures further comprises displaying them publically on the Internet website; the voting device further comprises a second module programmed to accept votes made by viewers of the Internet website device; and the step of providing publically a vote count further comprises displaying the vote count on the Internet website.

It is another aspect, advantage, objective and embodiment to provide a method wherein the step of displaying publicly the accepted pictures further comprises displaying them publically on a television show; the voting device further comprises a telephone number having a DTMF (Dual-Tone Multi-Frequency) input module programmed to accept votes made by viewers of the televison show; and the step of providing publically a vote count further comprises displaying the vote count on the television show.

It is another aspect, advantage, objective and embodiment to provide a method wherein the unacceptable photographs are selected from the set consisting only of: photographs not of children at the time the photograph is taken, indecent photographs, photographs which are not flattering to the child pictured, and combinations thereof.

It is another aspect, advantage, objective and embodiment to provide a method further comprising the step of: selling advertising space to advertisers; and displaying said advertising space at one time selected from the group consisting of: the time of accepting from contestants images of children, the time of publically displaying the images, the time of providing a voting device capable of accepting and counting votes from viewers; and the time of providing publicly a vote count of the images.

It is another aspect, advantage, objective and embodiment to provide a method further comprising the step of: awarding to the contestants a prize based upon the final result of the voting.

It is another aspect, advantage, objective and embodiment to provide a method further comprising the step of awarding to the individuals whose childhood image is displayed publically a prize based upon the final result of the voting.

It is another aspect, advantage, objective and embodiment to provide a method of holding a contest further comprising the step of: after the termination of the contest, maintaining the accepted pictures in a database accessible to the general public.

It is another aspect, advantage, objective and embodiment to provide a method of holding a contest comprising: defining a first time period having a first beginning date and a first ending date, defining a second time period having a second beginning date and a second ending date, wherein the second beginning date is substantially prior to the first beginning date, accepting from contestants images from the second time period, filtering out unacceptable images, displaying publicly the accepted images; providing a voting device capable of accepting and counting votes from viewers; and providing publicly a vote count of the images.

### BRIEF DESCRIPTION OF THE DRAWINGS

FIG. 1 is a block diagram of a simple overview of the method of the invention at a highest level of abstraction.

FIG. 2a is a PRIOR ART time-line of how contests are normally held.

FIG. 2b is an illustration of the time periods which may be used by contests of the present invention.

FIG. 3 is a block diagram of an Internet device first embodiment of the invention.

FIG. 4 is a block diagram of a multi-mode device second embodiment of the invention.

### INDEX TO REFERENCE NUMERALS

Start Step 102
Users Provide Images Step 104
Jurors Vote on Images Step 106
Count Votes Step 108
End Step 110
Earliest Present Child Date 201
Excluded Early Period “a” 202
Entry End Date 203
Contest Period “b” 204
Inception of Photography 205
Excluded Late Period “c” 206
First Period Begin Date 207
Pre-Photography Period “A” 208
Present Day 209
Photography Period B 210
First Period End Date 211
Current Period “C” 212
Current Period “D” 214
Internet Website Device 302
Network 304
Computer 306
Administration Site 308
Photo Requirements 401
Contest Participants 402
Contest Administration 403
Time Line 404
Age Limit of Person at Time of Image 405
Acceptable Photographs 406
Any Location 407
Any Gender 408
Date of Inception of Photography 409
Picture Uploads 410a, 410b, 410c
Non-Computer Participants 411
Mail Delivery 412
Track Ongoing Results 413
User Client Computer 414
Vote on Random Pictures 415
TV Audience 416
TV Program 417
View/Vote 418
User Login 420
Administration 421
Administration Server 422
Count Votes 423
Jury's Final Decision 424
Winner Announced 425

### DETAILED DESCRIPTION

For purposes of this invention, the words “image”, “picture” and “photograph” are used interchangeably to indicate an accurate and true to life portrayal of an individual as distinguished from various art forms such as painting, computer generated graphics, artistic photography, animation or other methods producing less than exact results. Thus conventional silver-halide photography, electronic cameras and so on are included but portrait paintings and the like are excluded.

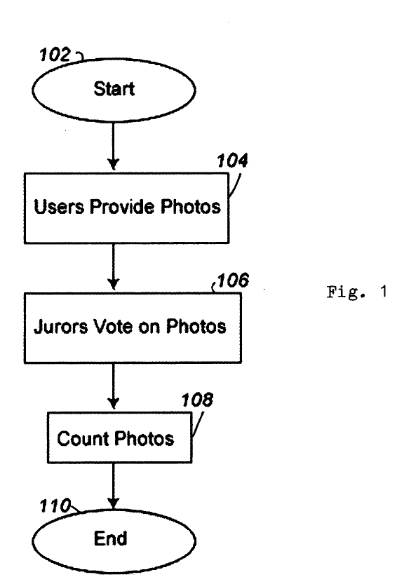

FIG. 1 is a block diagram of a simple overview of the method of the invention at a highest level of abstraction. Start Step 102 leads to Users Provide Images Step104. During the time frame during which users may provide images, the users/contestants may submit images for inclusion in the method/contest. As will be explained later, limited filtering applies to this step. Jurors Vote on Images Step 106 provides a time or time span during which jurors may vote on the images. Jurors, for purposes of this application, may be television viewers, individuals viewing a website, individuals at a physical comparison event showing the images, a small panel of judges, callers to a telephone number, individuals submitting votes by other means (E-mail, regular mail), and so on. Voting may occur by an acceptable method. Voters may be asked to compare subsets of the photographs and select a “best” from the group, or assign a numerical score to each photograph in isolation, etc. Count Votes Step 108 allows the votes to be tallied. In the presently preferred embodiments, the vote counting occurs at a time simultaneous with the voting, with an on-going tally. In other embodiments, the vote counting occurs after vote casting. End Step 110 ends the contest.

By this means, the goal of a more scientific sample of human opinion regarding comparative beauty may be obtained. Various alternative embodiments may be employed to further enhance the results, depending upon desired data return or commercial valuation.

In the preferred embodiment, no entry fee need be charged as the database assembly may pay for itself via sales of sponsorship. In one embodiment, a variable entry fee may be used to weight the desired data return to be more accurately reflective of human opinion variations. The entry fee may be varied so as to favor regions or cultures otherwise less likely to respond to call for images and entrants. This variation in entry fee may occur as a scientific function of cultural wealth, Internet penetration rates, or other factors. A negative entry fee (that is, a system in which contestants are paid to provide their images) may also be used, as well as a conditional positive or negative entry fee in which results of world-wide voting on the image determine a rebate level to the entrant.

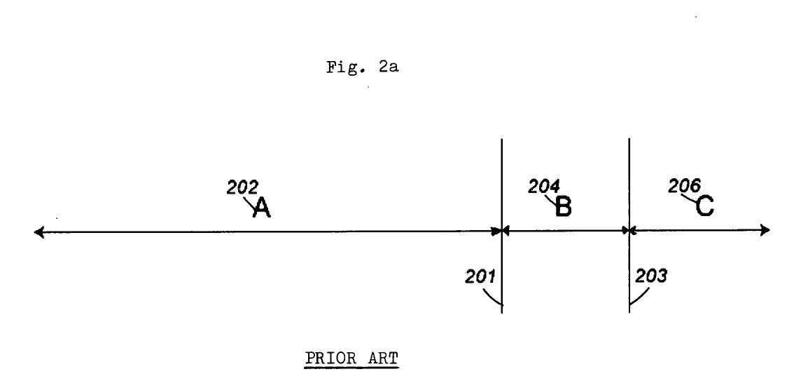

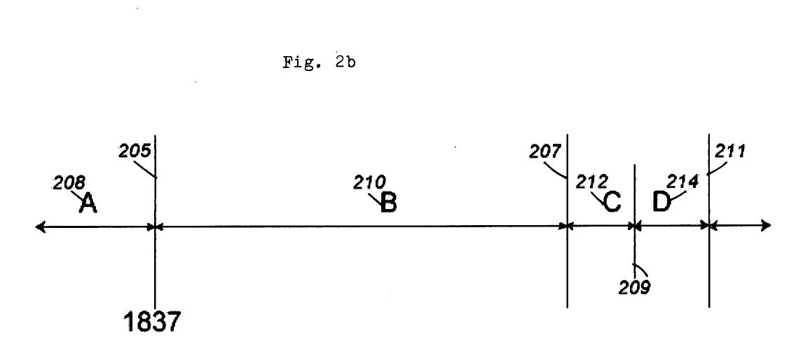

FIG. 2a is a PRIOR ART time-line of how contests are normally held. FIG. 2b is an illustration of the time periods which may be used by contests of the present invention. The PRIOR ART time line of FIG. 2a shows an Earliest Present Child Date 201. This corresponds to the earliest date on which someone could have an electronic image or photograph taken and still be a child of the appropriate age under the rules of the prior art contest. Thus, individuals and images may fall into Excluded Early Period “a” 202, a period of time before the contest. For example, a contest might specify that it was limited to individuals under the age of 8 as of Jan. 1^{st}, 2004, which would be an example of an Entry End Date 203. In that scenario, at any time prior to Jan. 2^{nd}, 1996, it would be impossible to have taken a picture of a legal contestant. While anyone born after that date and prior to January 2^{nd}, 2004 would be in Contest Period “b” 204 and thus included. Anyone born on or after January 2^{nd}, 2004 would fall into Excluded Late Period “c” 206.

The present invention is shown in time line fashion as having an Inception of Photography Date 205, functionally around 1837. Prior to that time, actual images of an individual (electronic, silver halide based or other) would have been impossible to produce. This is Pre-Photography Period “A” 208. As of inception of photography date 205, and until First Period Begin Date 207, Photography Period “B” 210 is the time frame during which photographs may have been taken. Thus, the age of the individual at First Period End Date 211 is irrelevant. Any childhood photograph which meets the requirements set out and is submitted during Current Period “C” 212 or Current Period “D” 214 (a division made around a hypothetical “Present Day 209”) would be eligible to compete.

Note that eligibility to compete would thus the limited by the subject matter of the photograph, and for a child contest, would be based upon the image showing a child. Other limitations will apply, as discussed below, but the contest is not time bound to those of the proper age at the time of the contest.

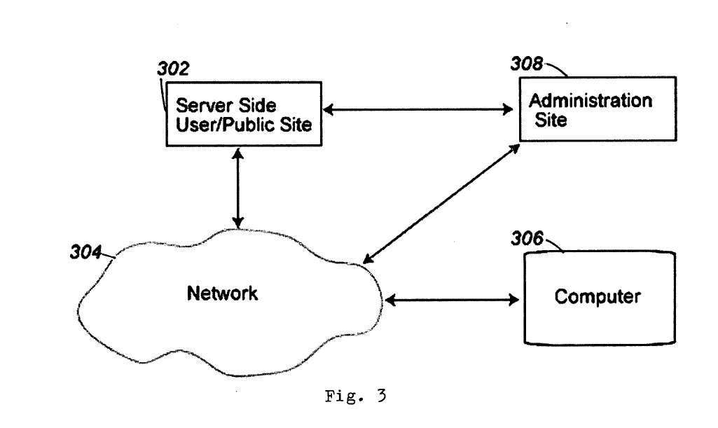

FIG. 3 is a block diagram of an Internet device first embodiment of the invention. Internet Website Device 302 might be a website offering at least four modules:
1) a reception device capable of accepting from contestants images of children from any time since the inception of photography;
2) a filtering device capable of filtering out unacceptable photographs, wherein images of children from any time since the inception of photography are acceptable;
3) a display module capable of publicly displaying accepted pictures;
and 4) a voting device capable of accepting and counting votes from viewers.

Other modules might employed as well, for example, in the testing website embodiment (not presently available to the public on the Internet), a fifth module displays an ongoing vote tally. Other modules might limit eligibility of the jurors (for example, the general public) by identity, age, location and so on, so that only selected jurors could vote. One restriction would be to prevent non-humans from voting: machine voting by a software device would ruin the validity of the system. Another restriction might be to limit voting to one time per individual.

Another module may be employed to increase the scientific or cultural value of the data returned desired by use of the method. For example, a weighting module may weight the frequency of display of a given image in relation to the overall proportion of images from a desired region which is under or over-represented in the sample, or to weight votes on the same basis or other bases discussed previously, or to weight entry fees on a continuous basis, and so on.

Voting may be scientifically weighted or scaled as previously discussed in relation to entry fees in order to provide a more desirable data return and provide a more accurate reflection of human variations in opinion. That is, voting weight may be proportionally balanced according a function of relative regional wealth, Internet penetration rates, population, willingness to vote or other factors. By such means, the balance of voting may be adjusted to more accurately reflect global or regional value systems regarding human attractiveness.

Network 304 may be the Internet, a dedicated network, an Intranet, or other computer network, or another communications network such as a television network. Computer 306 or a similar device such as a terminal or television may be used to access such a website embodiment. Administration Site 308 allows control of the Internet Website Device 302; both may be server side architecture, and may be in other embodiments a single software device.

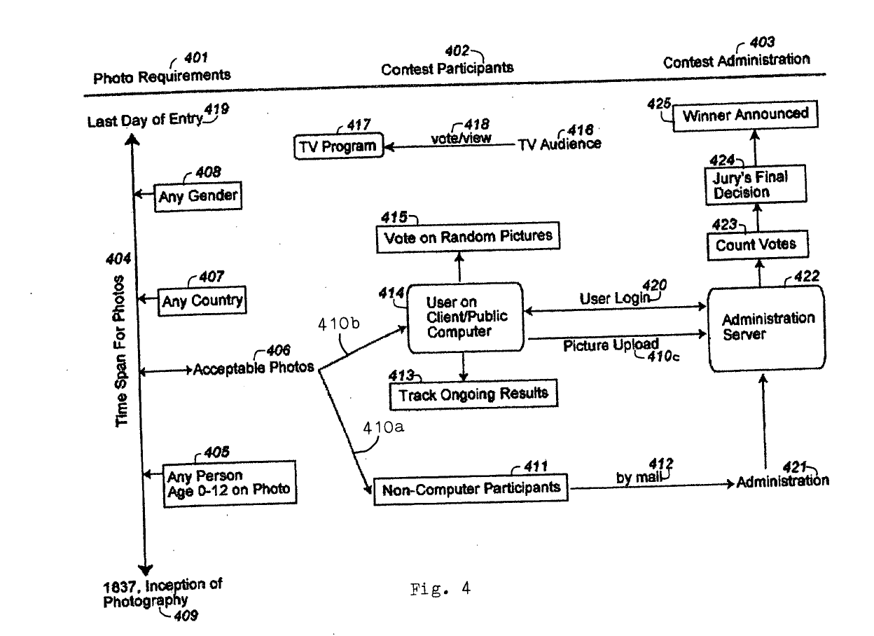

FIG. 4 is a block diagram of a multi-mode device second embodiment of the invention.

Time Line 404 has blocks indicating various types of Photo Requirements 401 (the left column of FIG. 4). Contest Participants column 402 and Contest Administration column 403 will be discussed in the succeeding paragraphs herein. Time Line 404 has a number of blocks indicating various limitations: Age Limit of Person at Time of Image 405, such as photographs only of individuals of a given age (for example photographs of individuals not children at the time the photograph is taken), Acceptable Photographs block 406, which may limit photographs so as to exclude indecent photographs, photographs which are not flattering to the child pictured, other similar limitations and combinations thereof. Any Location block 407 may indicate a world-wide poll, as in the best mode now contemplated for carrying out the invention, or may use a different geographic limitation. Any Gender block 408 may limit or not limit the contest to contestants of a given gender. Date of Inception of Photography 409 is the only functional limitation on the age of the image taken and thus on the age of the individual whose image is submitted. (This is different from Age Limit of Person at Time of Image 405, which refers to the age the person must be within at the time of the image.) Yet another embodiment may filter images based upon veracity of the image to the subject, so as to prevent falsification of images by contestants merely interested in collecting a prize.

Picture Upload 410b, 410c depend upon the provider of the contest providing a reception device capable of accepting from contestants photographs of children from any time since the inception of photography.

Non-Computer Participants 411 may use Mail Delivery 410a, 412 or other delivery in cases in which a non-computer embodiment is used, such as this multi-mode embodiment of FIG. 4. Such votes may also be cast in person, via telephone, etc.

User Client Computer 414 on the other hand may be used for those viewers and jurors using computer access to the images and voting results. Note that uploads of contestant images may occur from user client computer 414.

TV Audience 416 may also use TV Program 417 to View/Vote 418. Such voting may occur by means of two way television service, by means of the control system of a cable type television service, may occur by means of telephone, facsimile, e-mail, mail 412, user/client computer 414, and so on. User Login 420 may allow limited access to Administration block's 421 Administration Server 422 for such computer users. Such limited access may include photograph upload 410c, voting, viewing images, and combinations thereof.

Track Ongoing Results block 413 is a feature by which viewers and jurors (which two groups may be the same, or may overlap) may appreciate the on-going nature of the contest and may check results of the contest as it transpires, regardless of whether the contest takes seconds, minutes, hours, days, weeks, months or years to complete.

Vote on Random Pictures 415 is one possible method of voting. Since in any large pool of contestants, the number will quickly grow too large of a single human juror to make intelligent decisions, each juror may be given only a subset of the pool to vote upon. This subset may be random, may be geographic, temporal, based upon features of the contestants or the juror, other attributes or combinations thereof. Frequency as a function of desired data return is, as discussed, a potential method of providing more accurate sampling.

Count Votes 423 however, is an example of a protected administrative function users would not be allowed access to. Jury's Final Decision block 424 leads to Winner Announced block 425.

In the presently preferred embodiment and best mode presently contemplated for carrying out the invention, awarding to the contestants a prize based upon the final result of the voting is a part of the sequence of steps, and in alternative embodiments, awarding to the individuals whose childhood image is displayed publically a prize based upon the public display may also occur.

Method embodiments for comparing images of children have the following steps:
0) selling advertising space to advertisers;
1) providing a reception device capable of accepting from contestants photographs of children from any time since the inception of photography;
2) providing a filtering device capable of filtering out unacceptable photographs, wherein photographs of children from any time since the inception of photography are acceptable;
3) displaying publicly accepted photographs;
4) providing a voting device capable of accepting and counting votes from viewers; and
5) providing publicly a vote count of the photographs,
6) displaying the advertising space at one time selected from the group consisting of: the time of accepting from contestants images of children, the time of publically displaying the images, the time of providing a voting device capable of accepting and counting votes from viewers; and the time of providing publicly a vote count of the images.

By this method, photographs of children from any time since the inception of photography may be compared by means of a poll.

As noted previously, the reception device may further comprise an Internet website device having a first module programmed to accept images uploaded by contestants, so that the step of displaying publicly the accepted pictures further comprises displaying them publically on the Internet website. The voting device may comprise a second module programmed to accept votes made by viewers of the Internet website device, and the step of providing publically a vote count may comprise displaying the vote count on the Internet website.

In television embodiments, the step of displaying publicly the accepted pictures further comprises displaying them publically on a television show, the voting device further comprises a telephone number having a DTMF input module programmed to accept votes made by viewers of the televison show; and the step of providing publically a vote count further comprises displaying the vote count on the television show.

The device of the invention may then be transformed into an archive or museum (on-line or otherwise accessible to the general public) for such images. Over the course of repeated contests at different times or for different regions, classifications of children, etc, it is thus possible to assemble a global database of childhood images for later scientific and cultural purposes. This embodiment thus creates a permanent scientific resource for later studies.

This disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the claims accompanying this disclosure.

1. A method of determining the best image of a child, the method comprising:
1) accepting images of children from any time since the inception of photography;
2) displaying publicly the accepted images; and
3) accepting votes from the general public on the images.

2. The method of claim 1, further comprising the following step after step 1) and prior to step 2):
1.5) filtering unacceptable photographs.

3. The method of claim 1, further comprising the following step after step 3):
4) weighting votes as a function of desired data return.

4. The method of claim 1, wherein the step 1.5) of accepting images of children furthermore comprises charging a variable entry fee as a function of desired data return.

5. The method of claim 1, wherein the step 2) of displaying the accepted images furthermore comprises displaying the images at a frequency determined as a function of desired data return.

6. A method of holding a contest comprising: determining the best image of a child from any time since the inception of photography.

7. A method comparing images of children comprising:
providing a reception device capable of accepting from contestants photographs of children from any time since the inception of photography;
providing a filtering device capable of filtering out unacceptable photographs, wherein photographs of children from any time since the inception of photography are acceptable;
displaying publicly accepted photographs;
providing a voting device capable of accepting and counting votes from viewers; and
providing publicly a vote count of the photographs,
whereby photographs of children from any time since the inception of photography may be compared by means of a poll.

8. The method of claim 7, wherein:
the reception device further comprises an Internet website device having a first module programmed to accept images uploaded by contestants;
the step of displaying publicly the accepted pictures further comprises displaying them publically on the Internet website;
the voting device further comprises a second module programmed to accept votes made by viewers of the Internet website device; and
the step of providing publically a vote count further comprises displaying the vote count on the Internet website.

9. The method of claim 7, wherein
the step of displaying publicly the accepted pictures further comprises displaying them publically on a television show;
the voting device further comprises a two-way television control module programmed to accept votes made by viewers of the televison show; and
the step of providing publically a vote count further comprises displaying the vote count on the television show.

10. The method of claim 7, wherein
the step of displaying publicly the accepted pictures further comprises displaying them publically on a television show;
the voting device further comprises a telephone number having a DTMF input module programmed to accept votes made by viewers of the televison show; and
the step of providing publically a vote count further comprises displaying the vote count on the television show.

11. The method of claim 7, wherein the unacceptable photographs are selected from the set consisting only of: photographs not of children at the time the photograph is taken, indecent photographs, photographs which are not flattering to the child pictured, and combinations thereof.

12. The method of claim 7, further comprising the step of:
selling advertising space to advertisers; and
displaying said advertising space at one time selected from the group consisting of: the time of accepting from contestants images of children, the time of publically displaying the images, the time of providing a voting device capable of accepting and counting votes from viewers; and the time of providing publicly a vote count of the images.

13. The method of claim 7, further comprising the step of:
awarding to the contestants a prize based upon the final result of the voting.

14. The method of claim 7, further comprising the step of:
awarding to the individuals whose childhood image is displayed publically a prize based upon the public display.

15. The method of claim 7, further comprising the step of:
after the termination of the contest, maintaining the accepted pictures in a database accessible to the general public.
